(19) United States
(12) Patent Application Publication
(10) Pub. No.: US 2016/0297973 A9
(43) Pub. Date: Oct. 13, 2016

(54) PRIMER COMPOSITIONS FOR APPLICATION TO SHEET MATERIALS AND METHODS OF APPLYING SAME

(71) Applicant: PPG Industries Ohio, Inc., Cleveland, OH (US)

(72) Inventors: Irina G. Schwendeman, Wexford, PA (US); Carole A. Conley, Saxonburg, PA (US); Edward R. Millero, JR., Gibsonia, PA (US)

(21) Appl. No.: 14/198,629

(22) Filed: Mar. 6, 2014

Related U.S. Application Data
(63) Continuation-in-part of application No. 13/786,516, filed on Mar. 6, 2013.
(60) Provisional application No. 61/661,532, filed on Jun. 19, 2012.

(51) Int. Cl. C09D 5/08; B05D 7/14; B05D 7/24; B05D 3/02

(52) U.S. Cl. CPC C09D 5/08; B05D 3/0272; B05D 7/14; B05D 7/24

(57) ABSTRACT

Waterborne primer coating compositions are applied to sheet metal substrates and rapidly cured. The primer coating compositions contain water, a latex resin and corrosion-inhibiting particles. The primer coating compositions may be applied to the metal sheets and rapidly cured at a rolling mill, followed by coiling of the coated sheets.

### CROSS REFERENCE TO RELATED APPLICATIONS

This application is a continuation-in-part of U.S. patent application Ser. No. 13/786,516, filed Mar. 6, 2013, which claims the benefit of U.S. Provisional Application Ser. No. 61/661,532, filed Jun. 19, 2012, both of which are incorporated herein by reference.

### FIELD OF THE INVENTION

The present invention relates to primer compositions for application to sheet materials, methods of primer compositions to sheet materials.

### BACKGROUND OF THE INVENTION

Sheet materials used in architectural and other applications often require corrosion resistant properties. For example, steel and other types of metal roofing sheet materials must withstand exposure to environmental conditions for extended periods of time. Galvanized steel roofing sheets have conventionally been pre-treated with chromium-containing compositions to increase corrosion resistance. Such pretreatments may be conducted on long strips of the steel, which are then coiled into rolls for subsequent use.

### SUMMARY OF THE INVENTION

An aspect of the invention provides a rapidly curable waterborne primer coating composition comprising water, latex resin and corrosion-inhibiting particles.

Another aspect of the invention provides a coated metal sheet comprising a metal substrate and a cured primer coating covering at least a portion of the metal substrate, wherein the cured primer coating comprises a latex resin and corrosion-inhibiting particles, and is cured for less than 10 second at a temperature of less than 350° F.

A further aspect of the invention provides a method of coating a sheet metal substrate comprising applying a primer coating composition comprising water, latex resin and corrosion-inhibiting particles onto the sheet material, and curing the primer coating composition at a temperature of less than 350° F. for a time of less than 10 seconds.

### BRIEF DESCRIPTION OF THE DRAWINGS

FIG. 1 is a partially schematic side view illustrating a method of applying a primer coating onto a metal sheet in rolling mill, including the use of a roll coater for applying a primer coating composition to the sheets and the use of in accordance with an embodiment of the present invention.

### DETAILED DESCRIPTION OF EMBODIMENTS OF THE INVENTION

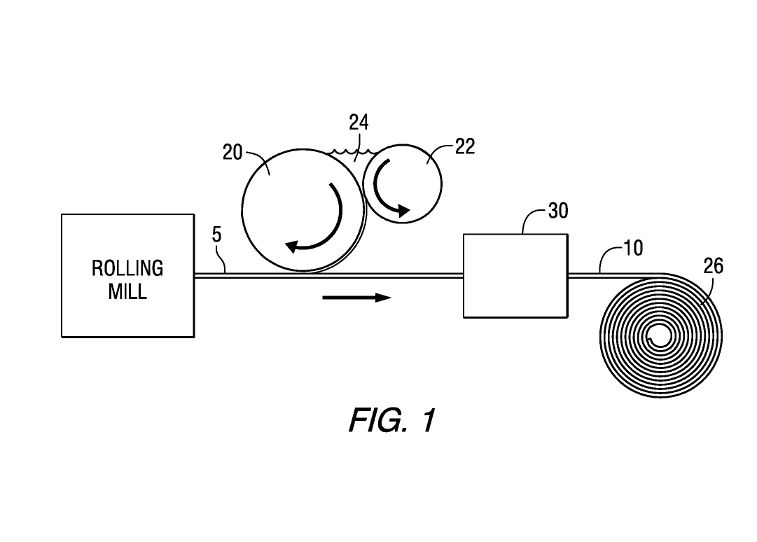

FIG. 1 schematically illustrates a roll coating method for applying primer coating compositions onto sheet materials in accordance with an embodiment of the present invention. In the embodiment shown, the coating operation may be conducted in a conventional rolling mill. Metal sheet material, such as galvanized steel, aluminum, or the like, is provided in a long strip 5 that passes under oppositely-rotating coating rollers 20 and 22, which are fed with a supply of a primer coating composition 24. The substrate sheet may be of any desired thickness, such as from 0.5 to 3 mm. For example, the thickness of galvanized steel roof sheeting materials may range from 0.5 to 2 mm in certain embodiments. The uncoated strip 5 passes under the coating rollers 20 and 22, where a layer of the primer coating composition 24 is deposited on the upper surface of the sheet material. After the primer coating composition 24 is deposited on the strip 5, the coated strip 10 passes through an oven 30 or any other known type of heating device such as an IR heat source to rapidly cure the primer coating composition. The coated sheet material 10 may be formed into a coil 26 for storage and transportation for use in various applications.

During the roll coating process, the primer coating composition is typically applied to the sheet material 5 with a wet film thickness of at least 1 micron, typically at least 1 or 5 microns. In certain embodiments, the wet film thickness of the coating material is from 5 to 15 or 20 microns. In certain embodiments, the deposition rate of the coating composition may be at least 200 ft/min, typically at least 300 ft/min or 350 ft/min.

After application, the primer coating compositions typically dry and cure quickly with minimal VOC emissions. As used herein, the terms “rapidly cure” and “rapidly curable” mean that the primer coating compositions fully cure within a reduced amount of time when subjected to elevated temperatures as compared to conventional primer compositions that are typically applied to metal substrates in the field. Curing times are typically in less than 20 seconds, for example, less than 10 or 5 seconds. Typical curing temperatures are below 350° F., for example, below 300° F. or 250° F. In certain embodiments, curing times may be less than 3 or 2 seconds at temperatures of 220° F. or 200° F., or less.

The primer coating may have a dry film thickness typically greater than 1 micron, for example, greater than 2 or 3 microns. In certain embodiments, the dry film thickness of the primer coating may be from 3 to 10 or 20 microns.

The primer coating compositions of the present invention may be waterborne. In certain embodiments, water may comprise from 20 to 80 weight percent of the primer coating compositions, for example, from 50 to 65 weight percent. In certain embodiments, the primer coating compositions comprise less than 10 weight percent organic solvents, for example, less than 7 or 4 weight percent, based on the total weight of the composition. The resin solids content of the primer coating compositions may be relatively high, for example, greater than 35 or 40 weight percent, based on the total weight of the composition.

The primer coating compositions may have little or no volatile organic content (VOC). For example, the primer coating compositions may comprise less than 1.5 weight percent VOCs, for example, less than 1 or 0.5 weight percent VOCs, based on the total weight of the composition. In certain embodiments, the primer coating compositions are substantially free of VOCs.

In accordance with embodiments of the invention, the primer coating composition comprises a latex resin. The latex resin may, or may not, be self-crosslinking. The latex resin typically comprises from 20 to 60 weight percent of the primer coating composition, for example, from about 30 to about 50 weight percent. In certain embodiments, suitable monomers used for preparing the latex resins may include vinyl aromatic monomers such as styrene, cycloaliphatic monomers such as cyclohexyl methacrylate, and long-chain aliphatic monomers such as 2-ethylhexyl acrylate, MMA and/or 2-ethylhexyl methacrylate. Other types of monomers include cyclohexene, 2-ethyl-1-hexene, cyclohexanol, alpha-methylstyrene, 2-ethylhexanol, 2-ethylhexyl acetate, methyl-4-phenyl butyrate, methyl myristate and/or methyl palmitate.

In certain embodiments, the monomers used in the latex resin comprise a vinyl aromatic compound, such as a vinyl aromatic monomer, which, in certain embodiments, comprises a compound that has a calculated Tg of least 100° C. Specific examples of vinyl aromatic compounds are styrene (which has a calculated Tg of 100° C.), α-methylstyrene (which has a calculated Tg of 168° C.), vinyltoluene, p-methylstyrene, ethylvinylbenzene, vinylnaphthalene, vinylxylenes, α-methylstyrene dimer (meth)acrylate, penta fluoro styrene, and the like. In certain embodiments, styrene or another vinyl aromatic monomer may comprise the most predominant monomer of the resin on a weight percent basis.

In certain embodiments, the monomers of the latex resin include cycloaliphatic (meth)acrylate monomers, such as trimethylcyclohexyl acrylate, t-butyl cyclohexyl acrylate, dicyclopentadiene (meth)acrylate, trimethylcyclohexyl methacrylate (calculated Tg of 98° C.), cyclohexyl methacrylate (calculated Tg of 83° C.), isobornyl methacrylate (calculated Tg of 110° C.), 2-ethylhexyl methacrylate, tetrahydrofurfuryl methacrylate, 3,3,5-trimethylcyclohexyl methacrylate (calculated Tg of 125° C.), and/or 4-t-butylcyclohexyl methacylate, and the like.

In certain embodiments, the monomers of the latex resin include an alkyl(meth)acrylate, which, in certain embodiments, comprises a compound that has a calculated Tg of least 100° C. Specific examples of alkyl(meth)acrylates are C₁-C²⁴ alkyl(meth)acrylates, such as methyl(meth)acrylate (which has a calculated Tg of 105° C.), propyl(meth)acrylate, butyl(meth)acrylate, isobutyl(meth)acrylate, hexyl(meth)acrylate, 2-ethylhexyl(meth)acrylate, octyl(meth)acrylate, decyl(meth)acrylate, dodecyl(meth)acrylate, pentadecyl(meth)acrylate, hexadecyl(meth)acrylate, octadecyl(meth)acrylate, and nonadecyl(meth)acrylate, and mixtures thereof. Other monomers include, for example, nitriles, such as acrylonitrile and/or methacrylonitrile.

Some non-limiting examples of latex resins that may be used in the primer coating compositions of the present invention are commercially available from Nuplex, Lubrizol, Rohm and Haas, Alberdingk Boley Company, Omnova and DSM Neoresins, such as Joncryl 1982, Caroboset CR-781, Alberdingk AC 2403, Alberdingk 2360, Neocryl XK-98 and the like.

The latex resin may have an average particle size of from 50 nm to 300 nm, for example from 60 nm to 100 or 150 nm; a glass transition temperature (Ta) of from −20 to 100° C., typically from zero to 20 or 50° C.; and an acid number of from 0 to 20, typically from 2 to 10.

The primer coating compositions also include at least one corrosion-inhibiting material such as chrome-containing or non-chrome-containing particles. As used herein, the term “corrosion-inhibiting” particles means particles which, when incorporated in the primer coating compositions of the present invention, provide at least 1,000 hours of salt spray corrosion resistance with no visible corrosion spots on the surface as measured by the ASTM B117 standard test. In certain embodiments, the corrosion-inhibiting particles may be provided in the form of a pigment or tint having a typical average particle size of from 0.1 to 5 microns, for example, from 0.2 to 3 microns or from 0.5 to 1.5 microns. The corrosion-inhibiting particles are typically present in an amount of from 1 to 30 weight percent based on the total weight of the primer coating composition, for example, from 2 or 3 to 25 weight percent. In certain embodiments, the corrosion-inhibiting particles comprise at least 5 or 8 weight percent, or at least 10 or 12 weight percent of the primer coating composition.

In accordance with certain embodiments of the invention, the coatings are substantially free of chrome. In such embodiments, chrome is not purposely added to the coating compositions and is only present in trace levels or as an impurity. In this embodiment, examples of non-chrome-containing corrosion-inhibiting particles include silicates such as calcium silicate, oxides, phosphorsilicates, phosphates, silica and the like. In certain embodiments, silica may be added to the primer coating compositions in amounts of from 15 to 30 weight percent, for example, from 20 to 25 weight percent. Some examples of silica include Lo-Vel 275 silica from PPG Industries and Aerosil 200 silica from Air Products.

In certain embodiments, chromate-containing materials may be added to the primer coating compositions. Example of chrome-containing corrosion-inhibiting particles include chromates such as strontium chromate and the like. The chrome-containing particles may be added in the amounts described above. In certain embodiments, the chrome-containing corrosion-inhibiting particles comprise at least 3 weight percent, for example, from 5 to 20 weight percent, or from 8 to 18 weight percent, or from 10 to 15 weight percent, based on the total weight of the primer coating composition.

In addition to the latex resin and corrosion-inhibiting particles, the primer coating compositions may further comprise at least one coalescing agent in an amount of up to 10 weight percent, for example, in an amount of from 2 to 3 weight percent, based on the total weight of the primer coating composition. Examples of suitable coalescing agents include butyl carbitol commercially available from Dow Chemical Company, Dowanol DPM, Dowanol DPnB, Dowanol PPh, butyl cellosolve or Dowanol DPnP. In accordance with embodiments of the present invention, the coalescing agents form a thin film around the latex resin particles, which helps them coalesce. Improved coalescence of the latex resin particles may result in very fine particle sizes and a uniform microstructure, which may provide improved corrosion protection in comparison with other types of coatings having larger resin particle sizes. For example, in accordance with certain embodiments of the present invention, the average resin particle size may be less than 150 nanometers, for example, less than 100 or 80 nanometers.

In certain embodiments, wax may be added to the primer coating compositions in amounts up to 10 weight percent, for example, from 0.5 weight percent, based on the total weight of the coating composition. Suitable types of wax include Ceraflour 913, Worleeadd 352, Aquamat 272, Aquamat 270, Aquacer 539, and combinations thereof. For example, wax sold under the designation Aquamat 272 by BYK Chemie may be used. The type and amount of wax may be controlled in order to improve scratch resistance of the coated sheet materials. For example, when the coated sheets are formed into coils, the use of wax additives may reduce or prevent scratching during the coiling an uncoiling processes, as well as during subsequent top coating and/or installation and use of the coated sheet materials. In certain embodiments, the amount of wax added to the primer coating composition is limited in order to avoid unwanted slippage when the coated sheets are coiled, e.g., to prevent unwanted “telescoping” of the coils due to low friction between the adjacent coil layers.

Various other additives may optionally be added to the primer coating compositions in accordance with certain embodiments of the invention. For example, suitable additives include thickeners, defoamers, surfactants, rust inhibitors, pH control agents, and tints such as titanium dioxide and the like typically used in primers.

Suitable thickeners include Acrysol ASE-60, Aquatix 8421, DSX-1550, and Laponite RD. When used, such thickening agents may be present in amounts up to 7 weight percent, for example, from 0.5 to 4 weight percent, based on the total weight of the primer coating composition.

Suitable defoamers include BYK-011, BYK-20, BYK-32, BYK 34 and Drewplus L-419 available from Ashland in amounts up to 2 weight percent, for example, from 0.1 to 0.5 weight percent, based on the total weight of the primer coating composition.

Suitable surfactants include Zonyl FSP available from DuPont, Surfynol 104E available from Air Products, BYK 346, and BYK348 in amounts up to 2 weight percent, for example, from 0.1 to 0.5 weight percent, based on the total weight of the primer coating composition.

Suitable rust inhibitors include Halox 550, Halox Flash X-150, 330, Halox SZP-391, ammonium benzoate, and sodium nitrite in typical amounts up to 1 weight percent, for example, from 0.4 to 0.6 weight percent, based on the total weight of the primer coating composition.

In certain embodiments, the primer coating compositions are substantially free of certain metal salts such as metal phosphates, phosphocarbonates and phosphosilicates. For example, the compositions may be substantially free of zinc phosphate, calcium phosphate, calcium phosphosilicate and/or calcium-enriched silica.

Suitable pH control agents include any water soluble amine such as dimethylethanol amine (DMEA) available from Avecia in typical amounts up to 1 weight percent, for example, from 0.01 to 0.2 weight percent, based on the total weight of the primer coating composition.

In certain embodiments, at least one colored pigment or tint may be added to the primer coating compositions. Colored pigments and tints are different from reflective interference pigments and include standard inorganic and organic pigments, such as those found in conventional paints and primers. For example, various colored pigments are listed in the Dry Color Manufacturers Association (DCMA) classifications. Such colored pigments and tints typically comprise particles having substantially equiaxed morphologies, e.g., aspect ratios of about 1:1, in comparison with plate-like and sheet-like reflective interference pigments having relatively high aspect ratios. One suitable type of colored pigment includes TiO₂ in an amount up to 35 weight percent, for example, from 1 to 25 weight percent, based on the total weight of the primer coating composition. Aquext white tint commercially available from PPG Industries and Corrosperse 176E chrome tint commercially available from Wayne Pigments are examples of suitable tints.

In certain embodiments, conductive particles such as graphenic carbon particles may be added to the primer coating compositions in amounts of up to 5 weight percent or more, for example, from 1 to 2 weight percent based on the total weight of the primer coating composition. Such graphenic carbon particles may provide improved thermal emissivity properties. The graphenic carbon particles may be obtained from commercial sources, or may be made in accordance with the methods and apparatus described in U.S. application Ser. Nos. 13/249,315 and 13/309,894, which are incorporated herein by reference.

The following examples illustrate various aspects of the present invention, but are not intended to limit the scope of the invention.

### EXAMPLES

Primer coating compositions comprising chrome or non-chrome corrosion-inhibiting particles were prepared as described in Table 1 below, Sample No. 1 contained a chrome tint, while Sample No. 2 was chrome-free.

TABLE 1
Primer Coating Compositions

| | Sample No. 1 | Sample No. 2 |
|---|---|---|
| | (Chrome-based | (Non-Chrome- |
| Components | Primer | based Primer) |
| Acrylic Latex Resin | 179.07 | 155.65 |
| Deionized Water | 53.27 | 80.77 |
| Defoamer | 0.54 | 0.47 |
| Surfynol Surfactant | 1.09 | 0.94 |
| Surfactant | 1.15 | 1.0 |
| Chrome Tint | 43.92 | — |
| Silica | — | 86.64 |
| White Tint | 57.80 | 34.66 |
| Rust Inhibitor | 2.67 | 2.32 |
| Thickener | 4.48 | 2.88 |
| Deionized Water | 4.48 | 2.88 |
| pH Control Agent | 0.90 | 2.07 |
| Deionized Water | 0.90 | 2.07 |
| Wax | 11.45 | 9.95 |
| Total Weight in Grams | 361.72 | 382.32 |

The components listed in Table 1 were added together in the order described under gentle stirring. The primer coating compositions were allowed to equilibrate overnight before panel preparation. Viscosity and pH were checked the next day. The primer coating compositions were applied to three different types of substrates using a wire drawdown bar. The three types of substrates were hot-dipped galvanized steel, aluminum, and steel and coated with zinc and aluminum commercially available under the designation Galvalume. The coated panels were placed in a conveyor oven set at a temperature of 260° C. and a line speed sufficient to obtain a peak metal temperature of 190° F. in two seconds dwell time. Some of the primer-coated panels were subsequently coated with three different types of top coats: high-bake waterborne topcoat commercially available from PPG under the designation Environ; a solvent-borne polyester-based topcoat commercially available from PPG under the designation Truform; and water-borne topcoat commercially available from PPG under the designation Environ MCL. Control panels comprising conventional chrome-containing and non-chrome containing primers were also made by applying either a chrome urethane primer from PPG, or a non-chrome urethane primer from PPG. The conventional urethane primers were applied by similar methods as described above, except longer cure times of at least 30 seconds at a higher peak metal temperature of 450° F. were required in order to fully cure the urethane primers. The coated panels were tested, with the results shown in the tables below.

TABLE 2
Primer Only

| | Sample No. 1 | Sample No. 2 | | |
|---|---|---|---|---|
| | Acrylic Latex | Acrylic Latex | Urethane | Urethane |
| Primer | Water Base | Water Base | Chrome | Chrome-Free |
| Description | Chrome | Chrome Free | Control | Control |
| % Volume Solids | 34.88 | 33.31 | 44.54 | 45.29 |
| PMT (° F.) | 190 F. | 190 F. | 450 F. | 450 F. |
| Dwell (sec.) | 2 | 2 | 30 | 30 |
| Substrate | USS Bare | USS Bare | USS Bare | USS Bare |
| | Galvalume | Galvalume | Galvalume | Galvalume |
| DFT (mils) | 0.20/0.30 | 0.20/0.30 | 0.20/0.30 | 0.20/0.30 |
| Gloss 60° | 11.8 | 3.4 | 3.5 | 3.1 |
| T-Bend: NP/NC | 2/5+ | 2/5+ | 0/5+ | 1/5 |
| Rev Impact-75 lbs | slpo/ncr | np/ncr | np/ncr | slpo/vslcr |
| X-Hatch Adhesion | 5 b | 5 b | 5 b | 5 b |
| MEK Mar | 2 | 2 | 100 | 3 |
| Pencil Hardness | 2 h | h | 2 h | h |

TABLE 3
Primer and Water-Based High Bake System Environ Topcoat

| | Sample No. 1 | Sample No. 2 | | Urethane |
|---|---|---|---|---|
| | Acrylic Latex | Acrylic Latex | Urethane | Chrome- |
| | Water Base | Water Base | Chrome | Free |
| Primer | Chrome | Chrome Free | Control | Control |
| Topcoat | Environ | Environ | Environ | Environ |
| % Volume Solids | 34.88 | 33.31 | 44.54 | 45.29 |
| PMT (° F.) | 190 F. | 190 F. | 450 F. | 450 F. |
| Dwell (sec.) | 2 | 2 | 30 | 30 |
| Substrate | USS Bare | USS Bare | USS Bare | USS Bare |
| | Galvalume | Galvalume | Galvalume | Galvalume |
| DFT Primer (mils) | 0.2-0.3 | 0.2-0.3 | 0.2-0.3 | 0.2-0.3 |
| DFT Topcoat (mils) | 0.7-0.8 | 0.7-0.8 | 0.7-0.8 | 0.7-0.8 |
| Gloss 60° | 28.9 | 23.1 | 35.4 | 34.5 |
| T-Bend: NP/NC | 2/5 | 5+/5 | 0/3 | 1/4 |
| Rev Impact-75 lbs | modpo/ncr | modpo/ncr | np/ncr | np/ncr |
| X-Hatch Adhesion | 1 b | 2 b | 5 b | 5 b |
| MEK Mar | 100 | 100 | 100 | 100 |
| Pencil Hardness | f | F | h | h |

TABLE 4
Primer and Truform Solvent-Borne Polyester Topcoat

| | Sample No. 1 | Sample No. 2 | | |
|---|---|---|---|---|
| | Acrylic Latex | Acrylic Latex | Urethane | Urethane |
| Primer | Water Base | Water Base | Chrome | Chrome-Free |
| Resin Code | Chrome | Chrome Free | Control | Control |
| Topcoat | Polyester | Polyester | Polyester | Polyester |
| % Volume Solids | 34.88 | 33.31 | 44.54 | 45.29 |
| #4 Zahn—25-30 sec. | | | | |
| Bar | 8 | 8 | 8 | 8 |
| PMT (° F.) | 190 F. (260) | 190 F. (260) | 450 F. (320) | 450 F. (320) |
| Dwell (sec.) | 2 (74) | 2 (74) | 30 (16.5) | 30 (16.5) |
| Fans | 5/5 | 5/5 | 5/5 | 5/5 |
| Substrate | USS Bare | USS Bare | USS Bare | USS Bare |
| | Galvalume | Galvalume | Galvalume | Galvalume |
| DFT Primer (mils) | 0.2-0.3 | 0.2-0.3 | 0.2-0.3 | 0.2-0.3 |
| DFT Topcoat (mils) | 0.7-0.8 | 0.7-0.8 | 0.7-0.8 | 0.7-0.8 |
| Gloss 60° | 17.3 | 17 | 11.3 | 13.1 |
| T-Bend: NP/NC | 4/5+ | 5/5+ | 0/5 | 2/5+ |
| Rev Impact-75 lbs | slpo/slcr | np/slcr | np/ncr | np/ncr |
| X-Hatch Adhesion | 5 b | 5 b | 5 b | 5 b |
| MEK Mar | 100 | 100 | 100 | 100 |
| Pencil Hardness | h | h | 2 h | 2 h |

TABLE 5
Primer and Low-Bake Waterborne Solar White Topcoat

| | Sample No. 1 | Sample No. 2 | | Urethane |
|---|---|---|---|---|
| | Acrylic Latex | Acrylic Latex | Urethane | Chrome- |
| Primer | Water Base | Water Base | Chrome | Free |
| Resin Code | Chrome | Chrome Free | Control | Control |
| Topcoat | SolarWhite | SolarWhite | SolarWhite | SolarWhite |
| % Volume Solids | 34.88 | 33.31 | 44.54 | 45.29 |
| PMT (°F) | 190 F. | 190 F. | 450 F. | 450 F. |
| Dwell (sec.) | 2 | 2 | 30 | 30 |
| Substrate | USS Bare | USS Bare | USS Bare | USS Bare |
| | Galvalume | Galvalume | Galvalume | Galvalume |
| DFT Primer (mils) | 0.2-0.3 | 0.2-0.3 | 0.2-0.3 | 0.2-0.3 |
| DFT Topcoat (mils) | 0.7-0.8 | 0.7-0.8 | 0.7-0.8 | 0.7-0.8 |
| Gloss 60° | 39.8 | 36.3 | 38 | 39.2 |
| T-Bend: NP/NC | 0/5+ | 4/5+ | 0/5+ | 0/5+ |
| Rev Impact-75 lbs | slpo/sevcr | sevpo/sevcr | modpo/slcr | np/modcr |
| X-Hatch Adhesion | 5 b | 5 b | 5 b | 5 b |
| MEK Mar | 13 | 6 | 6 | 5 |
| Pencil Hardness | 2 b | 2 b | 2 b | 2 b |

In the foregoing tables, the T-Bend test was conducted in accordance with the standard ASTM D4145 test; the Rev Impact test was conducted in accordance with ASTM D2794, the X-Hatch Adhesion test was conducted in accordance with ASTM D3359, and the MEK Mar test was conducted in accordance with ASTM D5402. The Pencil Hardness test was conducted in accordance with ASTM D3363, in which a pencil is held firmly against the primer coating at a 45 degree angle and pushed away from the operator in a 0.25 inch stroke. Sufficient pressure is exerted downward and forward either to cut or scratch the film. The process is repeated down the hardness scale until a pencil is found that will not cut through the film to the substrate. The scale of hardness is: 6B (very soft) up to a 6H (very hard).

TABLE 6
Corrosion Test Results

| | Sample No. 1 | Sample No. 2 | | Urethane |
|---|---|---|---|---|
| | Acrylic Latex | Acrylic Latex | Urethane | Chrome- |
| | Water Base | Water Base | Chrome | Free |
| Primer | Chrome | Chrome Free | Control | Control |
| Topcoat | Environ | Environ | Environ | Environ |
| ASTM B117 Salt | | | | |
| Spray (1216 hours) | | | | |
| Face | ok | f6 | ok | ok |
| Scribe | no scribe | 4 mm | 1 mm | 1 mm |
| Edge | 8 mm | 12 mm | 2 mm | 11 mm |
| Humidity (ASTM | | | | |
| G60-95) | | | | |
| Face | ok | m8 | ok | ok |
| Scribe | no scribe | 0.5 mm | ok | 0.5 mm |
| Edge | ok | 2 mm | ok | 0.5 mm |
| QCT (ASTM D4585 | | | | |
| (1216 Hours)) | | | | |
| Face | ok | d8 | f8 | f8 |

TABLE 7

| | Sample No. 1 | Sample No. 2 | | |
|---|---|---|---|---|
| | Acrylic Latex | Acrylic Latex | | |
| | Water Base | Water Base | Urethane Chrome | Urethane Chrome- |
| Primer | Chrome | Chrome Free | Control | Free Control |
| Topcoat | Polyester | Polyester | Polyester | Polyester |
| ASTM B117 Salt | | | | |
| Spray 1216 Hours | | | | |
| Face | f8 | f8 | ok | f8 |
| Scribe | 0.5 mm | 0.5 mm | 1 mm | 2 mm |
| Edge | 3 mm | 10 mm | 7 mm | 10 mm |
| Humidity (ASTM | | | | |
| G60-95) | | | | |
| Face | ok | d8 | ok | ok |
| Scribe | ok | ok | ok | ok |
| Edge | ok | ok | ok | ok |
| QCT (ASTM D4585 | | | | |
| (1216 Hours)) | | | | |
| Face | f4 | d8 | ok | ok |

TABLE 8

| | Sample No. 1 | Sample No. 2 | | Urethane |
|---|---|---|---|---|
| | Acrylic Latex | Acrylic Latex | Urethane | Chrome- |
| | Water Base | Water Base | Chrome | Free |
| Primer | Chrome | Chrome Free | Control | Control |
| Topcoat | SolarWhite | SolarWhite | SolarWhite | SolarWhite |
| ASTM B117 Salt | | | | |
| Spray 1216 Hours | | | | |
| Face | f8 | ok | ok | ok |
| Scribe | 0.5 mm | 0.5 mm | 2 mm | ok |
| Edge | 10 mm | 10 mm | 2 mm | 2 mm |
| Humidity (ASTM | | | | |
| G60-95) | | | | |
| Face | ok | md8 | d4 | d4 |
| Scribe | ok | ok | ok | ok |
| Edge | ok | ok | ok | ok |
| QCT (ASTM D4585 | | | | |
| (1216 Hours)) | | | | |
| Face | ok | m6 | d4 | md4 |

In accordance with the ASTM B117 Salt Spray test listed in the foregoing tables, panels are placed with taped cut edges in a 95 F/5% NaCl solution cabinet for 1216 hours. The panels are then removed from the cabinet and visually evaluated for any red or white rust, black spots and blister defects on the faces of the panels.

For purposes of this detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of“or” means “and/or” unless specifically stated otherwise, even though “and/or” may be explicitly used in certain instances.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A rapidly curable waterborne primer coating composition comprising:
water,
latex resin; and
corrosion-inhibiting particles.

2. The rapidly curable waterborne primer coating composition of claim 1, wherein the composition is capable of being cured in less than 10 seconds at a temperature of less than 350° F.

3. The rapidly curable waterborne primer coating composition of claim 1, wherein the corrosion-inhibiting particles comprise chrome and are present in an amount of at least 3 weight percent based on the total weight of the coating composition.

4. The rapidly curable waterborne primer coating composition of claim 3, wherein the corrosion-inhibiting particles comprise strontium chromate.

5. The rapidly curable waterborne primer coating composition of claim 1, wherein the corrosion-inhibiting particles are substantially free of chrome and are present in an amount of at least 5 weight percent based on the total weight of the coating composition.

6. The rapidly curable waterborne primer coating composition of claim 5, wherein the corrosion-inhibiting particles comprise a silicate, oxide, phosphate, phosphorsilicate or silica.

7. The rapidly curable waterborne primer coating composition of claim 1, wherein the corrosion-inhibiting particles comprise silica and are present in an amount of at least 10 weight percent based on the total weight of the coating composition.

8. The rapidly curable waterborne primer coating composition of claim 1, wherein the latex resin is self-crosslinking and is prepared from at least one vinyl aromatic monomer.

9. The rapidly curable waterborne primer coating composition of claim 1, wherein the primer coating composition has a volatile organic content of less than 1.5 weight percent based on the total weight of the composition.

10. The rapidly curable waterborne primer coating composition of claim 1, further comprising a coalescing agent, wax, viscosity enhancing agent, thickening agent, colored pigment and/or colored tint.

11. A coated metal sheet comprising:
a metal substrate; and
a cured primer coating covering at least a portion of the metal substrate, wherein the cured primer coating comprises a latex resin and corrosion-inhibiting particles, and is cured for less than 10 seconds at a temperature of less than 350° F.

12. The coated metal sheet of claim 11, wherein the corrosion-inhibiting particles comprise strontium chromate and/or silica.

13. The coated metal sheet of claim 11, wherein the cured primer coating has a dry film thickness of at least 1 micron.

14. The coated metal sheet of claim 11, wherein the metal is in the form of a coil.

15. A method of coating a sheet metal substrate comprising:
applying a primer coating composition comprising water, latex resin and corrosion-inhibiting particles onto the sheet material; and
curing the primer coating composition at a temperature of less than 350° F. for a time of less than 10 seconds.

16. The method of claim 15, wherein the primer coating composition is applied at a wet film thickness of at least 1 micron.

17. The method of claim 15, wherein the primer coating composition has a volatile organic content of less than 1.5 weight percent.

18. The method of claim 15, wherein the primer coating composition is applied by roll coating.

19. The method of claim 18, wherein the primer coating composition is applied at a rate of at least 200 ft/min.

20. The method of claim 15, wherein the primer is cured by passing the sheet material and applied primer coating composition through an oven at a temperature of less than 250° F. for a time of less than 5 seconds.

21. The method of claim 15, further comprising applying a topcoat over at least a portion of the primer coating.

22. The method of claim 15, further comprising forming the coated metal sheet into a coil.
